(19) United States
(12) Patent Application Publication
(10) Pub. No.: US 2006/0094591 A1
(43) Pub. Date: May 4, 2006

(54) Polymerisation catalysts

(76) Inventors: Vernon Charles Gibson, London (GB); Damien Francis Reardon, Ontario (CA); Atanas Kostadinov Tomov, Croydon (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/541,366

(22) PCT Filed: Jan. 9, 2004
(86) PCT No.: PCT/GB04/00109

§ 371 Date: Jul. 5, 2005

(30) Foreign Application Priority Data
Jan. 14, 2003 (GB) 0300821.6

(51) Int. Cl. B01J 31/00; C07F 7/00

(52) U.S. Cl. 502/150; 502/167; 556/32

(57) ABSTRACT

A polymerisation catalyst comprising (1) a nitrogen-containing transition metal compound of Formula A, and (2) an organoaluminium or hydrocarbylboron activator, wherein either (a) R¹ and R² are monovalent groups or (b) R¹ and R² integrally form a divalent group R³ bridging the terminal nitrogen atoms of the triazene unit via carbon atoms; R¹ and R² and the divalent group R³ are (i) aliphatic hydrocarbon, (ii) alicyclic hydrocarbon, (iii) aromatic hydrocarbon, (iv) alkyl substituted aromatic hydrocarbon (v) heterocyclic groups and (vi) heterosubstituted derivatives of said groups (i) to (v); M is a metal from Group 3 to 11 of the Periodic Table or a lanthanide metal; X is an anionic group, L is a neutral donor group; n is 1 or 2, y and z are independently zero or integers such that the number of X and L groups satisfy the valency and oxidation state of the metal M. The catalyst is used to polymerise 1-olefins especially ethylene and propylene. High molecular weight homo- and co-polypropylene are disclosed.

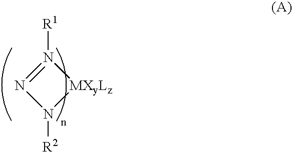

The present invention relates to transition metal-based polymerisation catalysts and to their use in the polymerisation and copolymerisation of olefins.

The use of certain transition metal compounds to polymerise 1-olefins, for example, ethylene or propylene, is well established in the prior art. The use of Ziegler-Natta catalysts, for example, those catalysts produced by activating titanium halides with organometallic compounds such as-triethylaluminium, is fundamental to many commercial processes for manufacturing polyolefins. Over the last three decades, advances in the technology have led to the development of Ziegler-Natta catalysts which have such high activities that olefin polymers and copolymers containing very low concentrations of residual catalyst can be produced directly in commercial polymerisation processes. The quantities of residual catalyst remaining in the produced polymer are so small as to render unnecessary their separation and removal for most commercial applications. Such processes can be operated by polymerising the monomers in the gas-phase, or in solution or in suspension in a liquid hydrocarbon diluent, or, in the case of propylene in bulk. Polymerisation of the monomers can be carried out in the gas phase (the “gas phase process”), for example by fluidising under polymerisation conditions a bed comprising the target polyolefin powder and particles of the desired catalyst using a fluidising gas stream comprising the gaseous monomer. In the so-called “solution process” the (co)polymerisation is conducted by introducing the monomer into a solution or suspension of the catalyst in a liquid hydrocarbon diluent under conditions of temperature and pressure such that the produced polyolefin forms as a solution in the hydrocarbon diluent. In the “slurry process” the temperature, pressure and choice of diluent are such that the produced polymer forms as a suspension in the liquid hydrocarbon diluent. These processes are generally operated at relatively low pressures (for example 10-50 bar) and low temperature (for example 50 to 150° C.).

Commodity polyethylenes are commercially produced in a variety of different types and grades. Homopolymerisation of ethylene with transition metal based catalysts leads to the production of so-called “high density” grades of polyethylene. These polymers have relatively high stiffness and are useful for making articles where inherent rigidity is required. Copolymerisation of ethylene with higher 1-olefins (e.g. butene, hexene or octene) is employed commercially to provide a wide variety of copolymers differing in density and in other important physical properties. Particularly important copolymers made by copolymerising ethylene with higher 1-olefins using transition metal based catalysts are the copolymers having a density in the range of 0.91 to 0.93. These copolymers which are generally referred to in the art as “linear low density polyethylene” are in many respects similar to the so called “low density” polyethylene produced by the high pressure free radical catalysed polymerisation of ethylene. Such polymers and copolymers are used extensively in the manufacture of flexible blown film.

Polypropylenes are also commercially produced in a variety of different types and grades. Homopolymerisation of propylene with transition metal based catalysts leads to the production of grades with a wide variety of applications. Copolymers of propylene with ethylene or terpolymers with ethylene and higher 1-olefins are also useful materials, often used in film applications.

In recent years the use of certain metallocene catalysts (for example biscyclopentadienylzirconiumdichloride activated with alumoxane) has provided catalysts with potentially high activity. Other derivatives of metallocenes have been shown to be potentially useful for producing polypropylene with good activity, molecular weight and tacticity control. However, metallocene catalysts of this type suffer from a number of disadvantages, for example, high sensitivity to impurities when used with commercially available monomers, diluents and process gas streams, the need to use large quantities of expensive alumoxanes to achieve high activity, and difficulties in putting the catalyst on to a suitable support.

It has also been reported, for example, by

(1) Kameda, Noriyuki, Ishii and Emiko, Coll. Sci. Technol., Nihon Univ., Funabashi, 274, Japan, Nippon Kagaku Kaishi (1983), (8), 1196-9

(2) Kameda, Noriyuki, Hattori, Miyabi, Coll. Sci. Technol., Nihon Univ., Funabashi, 274, Japan, Kobunshi Ronbunshu (1984), 41(11), 679-83

(3) Kameda, Noriyuki, Hattori, Miyabi, Coll. Sci. Technol., Nihon Univ., Funabashi, 274, Japan, Kobunshi Ronbunshu (1985), 42(8), 485-8

that rhodium complexes containing a diphenyl triazene ligand and containing triphenyl phosphine ligands can be used in certain solvents together with carbon tetrachloride to polymerise unsaturated monomers.

An object of the present invention is to provide a catalyst suitable for polymerising monomers, for example, olefins, and especially for polymerising ethylene alone or propylene alone, or for copolymerising ethylene with higher 1-olefins. A further object of the invention is to provide an improved process for the polymerisation of olefins, especially of propylene alone to provide homopolymers having very high molecular weights.

Yet another object of the present invention is to provide novel complexes based on certain transition metals.

The present invention provides a novel polymerisation catalyst comprising

(1) a nitrogen-containing transition metal compound having the following Formula A, and

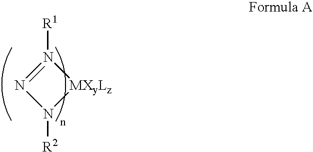

(2) an activating quantity of an activator compound selected from organoaluminium compounds and hydrocarbylboron compounds,

wherein in, Formula A, either (a) R¹ and R² are monovalent groups connected to the terminal nitrogen atoms of the triazene unit via carbon in said monovalent groups or (b)

R¹ and R² integrally form a divalent group R³ bridging the terminal nitrogen atoms of the triazene unit via carbon atoms;
the monovalent groups R¹ and R² and the divalent group R³ are independently selected from (i) aliphatic hydrocarbon, (ii) alicyclic hydrocarbon, (iii) aromatic hydrocarbon, (iv) alkyl substituted aromatic hydrocarbon (v) heterocyclic groups and (vi) heterosubstituted derivatives of said groups (i) to (v);
M is a metal from Group 3 to 11 of the Periodic Table or a lanthanide metal; X is an anionic group, L is a neutral donor group; n is 1 or 2, y and z are independently zero or integers such that the number of X and L groups satisfy the valency and oxidation state of the metal M.

The monovalent groups R¹ and R² and divalent group R³ are defined above as being selected from (i) aliphatic hydrocarbon, (ii) alicyclic hydrocarbon, (iii) aromatic hydrocarbon, (iv) alkyl substituted aromatic hydrocarbon (v) heterocyclic groups and (vi) heterosubstituted derivatives of said groups (i) to (v). In the case that the group is monovalent group R¹ or R² the valency bond is formally derived by removal of one hydrogen atom from the said hydrocarbon or heterocyclic compound. In the case that the group is the divalent group R³, an additional hydrogen atom is removed from the said compound to provide the second valency bond. The second valency bond can, in the case of C₂ or higher group, be on the same or different carbon atom from the first carbon atom. These defined groups preferably contain 1 to 30, more preferably 2 to 20, most preferably 2 to 12 carbon atoms. Examples of suitable aliphatic hydrocarbon groups for R¹ and R² are methyl, ethyl, ethylenyl, isopropyl and tert-butyl. Examples of suitable alicyclic hydrocarbon groups are adamantyl, cyclopentyl and cyclohexyl. Examples of suitable aromatic hydrocarbon groups are phenyl, biphenyl, naphthyl, phenanthrenyl and anthacenyl. Examples of suitable alkyl substituted aromatic hydrocarbon groups are benzyl, tolyl, mesityl, 2,6-diisopropylphenyl and 2,4,6-triisopropyl. Examples of suitable heterocyclic groups are 2-pyridinyl, 3-pyridinyl, 2-thiophenyl, 2-furanyl, 2-pyrrolyl, 2-quinolinyl. Suitable substituents for forming heterosubstituted derivatives of said groups R¹, R² and R³ are, for example, chloro, bromo, fluoro, iodo, nitro, amino, cyano, ether, hydroxyl and silyl, methoxy, ethoxy, phenoxy (i.e. —OC₆H₅), tolyloxy (i.e. —OC₆H₄(CH₃)), xylyloxy, mesityloxy, dimethylamino, diethylamino, methylethylamino, thiomethyl, thiophenyl and trimethylsilyl. Examples of suitable heterosubstituted derivatives of said groups (i) to (v) are 2-chloroethyl, 2-bromocyclohexyl, 2-nitrophenyl, 4-ethoxyphenyl, 4-chloro-2-pyridinyl, 4-dimethylaminophenyl and 4-methylaminophenyl. Suitable divalent groups for R³ are any of the aforesaid groups wherein an additional hydrogen atom has been formally removed top provide the second valency bond.

When the group R¹, R² or R³ is heterocyclic, the atom or atoms present in the rings as the heteroatom can be for example, oxygen, nitrogen, sulphur, phosphorus or silicon.

In the case that R¹ and R² form the integral unit R³, said unit connects at each end via a carbon atom to the two terminal nitrogen atoms of the triazene unit in Formula A. R³ suitably comprises a chain of at least 3 carbon atoms, including the two terminal carbon atoms, optionally containing one or more hetero atoms selected from oxygen, nitrogen, sulphur or silicon. Although R¹ and R² can form integral unit R³ it is preferred that they are separate groups. Preferably R¹ and R² are separate, identical groups. R¹ and R² are preferably hydrocarbyl groups and more preferably alkyl groups. Examples of preferred alkyl groups are methyl, ethyl, isopropyl, isobutyl, tert-butyl, adamantyl, cyclopentyl, cyclohexyl and n-hexyl.

M is preferably a metal selected from Groups 3 to 10 of the periodic table, more preferably selected from Sc, Ti, Zr, Hf, V, Nb, Ta, Cr, Mo, W, Mn, Fe, Ru, Co, Rh, Ir, Ni, Pd and Pt, and most preferably Ti, Zr, Hf, V, Nb, Ta, Cr, Fe, Co, Ni, Pd and Pt. The transition metals Ti, Zr, Nb, Ta, Hf, Ni and Pd are particularly preferred.

The anionic group X can be, for example, a halide, preferably chloride or bromide; or a hydrocarbyl group, for example, methyl, benzyl or phenyl; a carboxylate, for example, acetate or acetylacetate; an oxide; an amide, for example diethyl amide; an alkoxide, for example, methoxide, ethoxide or phenoxide. Alternatively, X can be a non-coordinating or weakly-coordinating anion, for example, tetrafluoroborate, a fluorinated aryl borate or a triflate. The anionic groups X may be the same or different and may independently be monoanionic, dianionic or trianionic.

The neutral donor group L can be, for example, a solvate molecule, for example diethyl ether or THF; an amine, for example, diethyl amine, trimethylamine or pyridine; a phosphine, for example trimethyl phosphine or triphenyl phosphine; or an olefin.

The value of y depends on the value of n, the charge on the anionic group X and the oxidation state of the metal M. For example, if M is titanium in oxidation state +4 and n is 2, then y is 2 if X is a monoanionic group (e.g. chloride) or y is 1 if X is a dianionic group (e.g. oxide); if M is titanium in oxidation state +4 and n is 1, then y is 3 if all X groups are monoanionic groups (e.g. chloride) or y is 2 if one X group is a dianionic group (e.g. oxide) and the other is monoanionic.

The activator compound (2) for the catalyst of the present invention is suitably selected from organoaluminium compounds and hydrocarbylboron compounds. Suitable organoaluminium compounds include trialkyaluminium compounds, for example, trimethylaluminium, triethylaluminium, tributylaluminium, tri-n-octylaluminium, ethylaluminium dichloride, diethylaluminium chloride and alumoxanes. Alumoxanes are well known in the art as typically the oligomeric compounds which can be prepared by the controlled addition of water to an alkylaluminium compound, for example trimethylaluminium. Such compounds can be linear, cyclic or mixtures thereof. Commercially available alumoxanes are generally believed to be mixtures of linear, cyclic and cage compounds. The cyclic alumoxanes can be represented by the formula [R⁶AlO]ₛ and the linear alumoxanes by the formula R¹⁷(R¹⁸AlO)ₛ wherein s is a number from about 2 to 50, and wherein R¹⁶, R¹⁷, and R¹⁸ represent hydrocarbyl groups, preferably C₁ to C₆ alkyl groups, for example methyl, ethyl or butyl groups.

Examples of suitable hydrocarbylboron compounds are dimethylphenylammoniumtetra(phenyl)borate, trityltetra(phenyl)borate, triphenylboron, dimethylphenylammonium tetra(pentafluorophenyl)borate, sodium tetrakis[(bis-3,5-trifluoromethyl)phenyl]borate, H⁺(OEt₂)[(bis-3,5-trifluoromethyl)phenyl]borate, trityltetra(pentafluorophenyl)borate and tris(pentafluorophenyl)boron.

In the preparation of the catalysts of the present invention the quantity of activating compound selected from organoaluminium compounds and hydrocarbylboron compounds to be employed is easily determined by simple testing, for example, by the preparation of small test samples which can be used to polymerise small quantities of the monomer(s) and thus to determine the activity of the produced catalyst. It is generally found that the quantity employed is sufficient to provide 0.1 to 20,000 atoms, preferably 1 to 2000 atoms of aluminium or boron per atom of M present in the compound of Formula A.

The catalyst of the present invention can, if desired, be utilised on a support material. Suitable support materials are, for example, silica, alumina, or zirconia, magnesia or a polymer or prepolymer, for example polyethylene, polystyrene, or poly(aminostyrene).

The following are examples of transition metal complexes that can be employed in the catalyst of the present invention:

1,3-bis(2,6-diisopropylphenyl)triazenido zirconium dichloride

1,3-bis(2,6-diisopropylphenyl)triazenido titanium dichloride

1,3-bis(adamantyl)triazenido titanium dichloride

1,3-bis(adamantyl)triazenido zirconium dichloride

Bis(1,3-diphenyltriazene)zirconium dichloride.THF

1,3-Bis(2,4,6-trimethylphenyl)triazenido zirconium dibenzyl

Bis-N,N-(2,6-diisopropylphenyl)triazenylphenyltriphenylphosphine nickel(II)

Bis(1,3-diphenyltriazene)zirconium dichloride.THF

The catalysts of the present invention can if desired comprise more than one of the defined transition metal compounds.

In addition to said one or more defined transition metal compounds, the catalysts of the present invention can also include one or more other types of transition metal compounds or catalysts, for example, transition metal compounds of the type used in conventional Ziegler-Natta catalyst systems, metallocene-based catalysts, or heat activated supported chromium oxide catalysts (e.g. Phillips-type catalyst). The catalysts of the present invention may also used in conjunction with other catalysts producing only 1-olefins, either inside or outside the polymerisation reactor, and in this way make copolymers of ethylene or propylene and these 1-olefins. Suitable catalysts for producing 1-olefins may produce only 1-butene, only 1-hexene or a distribution (for example, a Schulz-Flory distribution) of 1-olefins.

If desired the catalysts can be formed in situ in the presence of the support material, or the support material can be pre-impregnated or premixed, simultaneously or sequentially, with one or more of the catalyst components. The catalysts-of the present invention can if desired be supported on a heterogeneous catalyst, for example, a magnesium halide supported Ziegler Natta catalyst, a Phillips type (chromium oxide) supported catalyst or a supported metallocene catalyst. Formation of the supported catalyst can be achieved for example by treating the transition metal compounds of the present invention with alumoxane in a suitable inert diluent, for example a volatile hydrocarbon, slurrying a particulate support material with the product and evaporating the volatile diluent. The produced supported catalyst is preferably in the form of a free-flowing powder. The quantity of support material employed can vary widely, for example from 100,000 to 1 grams per gram of metal present in the transition metal compound.

The present invention further provides a process for the polymerisation and copolymerisation of 1-olefins, comprising contacting the monomeric olefin under polymerisation conditions with the polymerisation catalyst of the present invention.

Suitable monomers for use in making homopolymers using the polymerisation process of the of the present invention are, for example, ethylene, propylene, butene, hexene, and styrene. Preferred monomers are ethylene and propylene.

Suitable monomers for use in making copolymers using the polymerisation process of the present invention are ethylene; propylene, 1-butene, 1-hexene, 4-methylpentene-1, octane, methyl methacrylate, methyl acrylate, butyl acrylate, acrylonitrile, vinyl acetate, and styrene.

A particularly preferred process in accordance with the present invention is the copolymerisation of ethylene and or propylene with comonomers selected from 1-olefins, acrylic acid esters, vinyl esters and vinyl aromatic compounds. Examples of suitable comonomers are 1-butene, 1-hexene, 4-methylpentene-1, methyl methacrylate, methyl acrylate, butyl acrylate, acrylonitrile, vinyl acetate, and styrene.

Preferred polymerisation processes are the homopolymerisation of ethylene or the homopolymerisation of propylene or copolymerisation of ethylene with one or more of propylene, butene, hexane-1 and 4-methylpentene-1.

The polymerisation conditions can be, for example, bulk phase, solution phase, slurry phase or gas phase. If desired, the catalyst can be used to polymerise ethylene under high pressure/high temperature process conditions wherein the polymeric material forms as a melt in supercritical ethylene. Preferably the polymerisation is conducted under gas phase fluidised or stirred bed conditions.

Slurry phase polymerisation conditions or gas phase polymerisation conditions are particularly useful for the production of high-density grades of polyethylene. In these processes the polymerisation conditions can be batch, continuous or semi-continuous. In the slurry phase process and the gas phase process, the catalyst is generally fed to the polymerisation zone in the form of a particulate solid. This solid can be, for example, an undiluted solid catalyst system formed from the complex A and an activator, or can be the solid complex A alone. In the latter situation, the activator can be fed to the polymerisation zone, for example as a solution, separately from or together with the solid complex. Preferably the catalyst system or the transition metal complex component of the catalyst system employed in the slurry polymerisation and gas phase polymerisation is supported on a support material. Most preferably the catalyst system is supported on a support material prior to its introduction into the polymerisation zone. Suitable support materials are, for example, silica, alumina, zirconia, talc, kieselguhr, or magnesia. Impregnation of the support material can be carried out by conventional techniques, for example, by forming a solution or suspension of the catalyst components in a suitable diluent or solvent, and slurrying the support material therewith. The support material thus impregnated with catalyst can then be separated from the diluent for example, by filtration or evaporation techniques.

In the slurry phase polymerisation process the solid particles of catalyst, or supported catalyst, are fed to a polymerisation zone either as dry powder or as a slurry in the polymerisation diluent. Preferably the particles are fed to a polymerisation zone as a suspension in the polymerisation diluent. The polymerisation zone can be, for example, an autoclave or similar reaction vessel, or a continuous loop reactor, e.g. of the type well know in the manufacture of polyethylene by the Phillips Process. When the polymerisation process of the present invention is carried out under slurry conditions the polymerisation is preferably carried out at a temperature above 0° C., most preferably above 15° C. The polymerisation temperature is preferably maintained below the temperature at which the polymer commences to soften or sinter in the presence of the polymerisation diluent. If the temperature is allowed to go above the latter temperature, fouling of the reactor can occur. Adjustment of the polymerisation within these defined temperature ranges can provide a useful means of controlling the average molecular weight of the produced polymer. A further useful means of controlling the molecular weight is to conduct the polymerisation in the presence of hydrogen gas which acts as chain transfer agent. Generally, the higher the concentration of hydrogen employed, the lower the average molecular weight of the produced polymer.

The use of hydrogen gas as a means of controlling the average molecular weight of the polymer or copolymer applies generally to the polymerisation process of the present invention. For example, hydrogen can be used to reduce the average molecular weight of polymers or copolymers prepared using gas phase, slurry phase or solution phase polymerisation conditions. The quantity of hydrogen gas to be employed to give the desired average molecular weight can be determined by simple “trial and error” polymerisation tests.

Methods for operating gas phase polymerisation processes are well known in the art. Such methods generally involve agitating (e.g. by stirring, vibrating or fluidising) a bed of catalyst, or a bed of the target polymer (i.e. polymer having the same or similar physical properties to that which it is desired to make in the polymerisation process) containing a catalyst, and feeding thereto a stream of monomer at least partially in the gaseous phase, under conditions such that at least part of the monomer polymerises in contact with the catalyst in the bed. The bed is generally cooled by the addition of cool gas (e.g. recycled gaseous monomer) and/or volatile liquid (e.g. a volatile inert hydrocarbon, or gaseous monomer which has been condensed to form a liquid). The polymer produced in, and isolated from, gas phase processes forms directly a solid in the polymerisation zone and is free from, or substantially free from liquid. As is well known to those skilled in the art, if any liquid is allowed to enter the polymerisation zone of a gas phase polymerisation process the quantity of liquid is small in relation to the quantity of polymer present in the polymerisation zone. This is in contrast to “solution phase” processes wherein the polymer is formed dissolved in a solvent, and “slurry phase” processes wherein the polymer forms as a suspension in a liquid diluent.

The gas phase process can be operated under batch, semi-batch, or so-called “continuous” conditions. It is preferred to operate under conditions such that monomer is continuously recycled to an agitated polymerisation zone containing polymerisation catalyst, make-up monomer being provided to replace polymerised monomer, and continuously or intermittently withdrawing produced polymer from the polymerisation zone at a rate comparable to the rate of formation of the polymer, fresh catalyst being added to the polymerisation zone to replace the catalyst withdrawn from the polymerisation zone with the produced polymer.

In the polymerisation process of the present invention the process conditions, especially in the case of ethylene homo- or copolymerisation, are preferably gas phase fluidised or stirred bed polymerisation conditions.

When using the catalysts of the present invention under gas phase polymerisation conditions, the catalyst, or one or more of the components employed to form the catalyst can, for example, be introduced into the polymerisation reaction zone in liquid form, for example, as a solution in an inert liquid diluent. Thus, for example, the transition metal component, or the activator component, or both of these components can be dissolved or slurried in a liquid diluent and fed to the polymerisation zone. Under these circumstances it is preferred the liquid containing the component(s) is sprayed as fine droplets into the polymerisation zone. The droplet diameter is preferably within the range 1 to 1000 microns. EP-A-0593083, the teaching of which is hereby incorporated into this specification, discloses a process for introducing a polymerisation catalyst into a gas phase polymerisation. The methods disclosed in EP-A-0593083 can be suitably employed in the polymerisation process of the present invention if desired.

In the case that the polymerisation process of the present invention is employed to make homo- or copolymers of propylene, the polymerisation conditions can be gas, liquid (bulk), slurry or solution phase conditions. Homopolymers of propylene and copolymers of propylene with 0.01 to 20 weight % of one or more comonomer 1-olefins are preferred: Preferably the copolymers comprise propylene and one or more olefins selected from ethylene and C₄ to C₁₂ 1-olefins.

Using the process of the present invention and suitably adjusting the process conditions it is possible to achieve the production of high weight average molecular weight homopolymers and copolymers of propylene. Thus, for example, the present invention can be used to provide high molecular weight homopolymers of propylene or copolymers of propylene with 0.01 to 20 weight % of one or more comonomer 1-olefins, preferably selected from ethylene and C₄ to C₁₂ 1-olefins and having a weight average molecular weight in the range 0.7×10⁶ to 2.0×10⁷, preferably 1×10⁶ to 1.6×10⁷ most preferably 2×10⁶ to 1.20×10⁷.

In general, weight average molecular weights in the higher regions of the above ranges can be achieved by (1) reducing the trialkyl aluminium level (if any) in the cocatalyst, (2) to use perfluoroorganoboron compounds as activator, (3) using relatively low polymerisation temperature, (4) operating at high propylene pressure or in bulk propylene, (5) using hafnium as the transition metal in the complex and (6) operating in the absence of chain transfer agent (e.g. in the absence of added elemental hydrogen or at relatively low hydrogen concentrations).

The propylene hompopolymers and copolymers produced by the process of the present invention generally have atactic stereochemistry. However, it is believed that the production of isotactic and syndiotactic propylene polymers and copolymers can be achieved by suitable modification of the catalysts with component ligands or additional catalysts known in the art to provide stereoregular polymers.

A further aspect of the present invention provides a novel transition metal compound having the Formula C 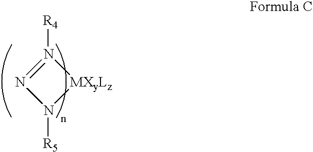
wherein either (a) R⁴ and R⁵ are monovalent groups connected to the terminal nitrogen atoms of the triazene unit of Formula C via carbon in said monovalent groups or (b) R⁴ and R⁵ integrally form a divalent group R⁶ bridging the terminal nitrogen atoms of the triazene unit of Formula A via carbon atoms;
the monovalent groups R⁴ and R⁵ and the divalent group R⁶ are independently selected from (i) aliphatic hydrocarbon, (ii) alicyclic hydrocarbon, (iii) alkyl substituted aromatic hydrocarbon (iv) heterocyclic groups and (v) heterosubstituted derivatives of said groups (i) to (iv);

M is a metal from Group 3 to 11 of the Periodic Table or a lanthanide metal; X is an anionic group; L is a neutral donor group; n is 1 or 2; y and z are independently integers such that the number of X and L groups satisfy the valency and oxidation state of the metal M.

The monovalent groups R⁴ and R⁵ and divalent group R⁶ are defined above as (i) aliphatic hydrocarbon, (ii) alicyclic hydrocarbon, (iii) alkyl substituted aromatic hydrocarbon (iv) heterocyclic groups and (v) heterosubstituted derivatives of said groups (i) to (iv). These-defined groups R⁴, R⁵, and R⁶ preferably contain 1 to 30, more preferably 2 to 20, most preferably 2 to 12 carbon atoms. Examples of suitable aliphatic hydrocarbon groups are niethyl, ethyl, ethylenyl, isopropyl and tert-butyl. Examples of suitable alicyclic hydrocarbon groups are adamantyl, cyclopentyl and cyclohexyl. Examples of suitable alkyl substituted aromatic hydrocarbon groups are benzyl, tolyl, mesityl, 2,6-diisopropylphenyl and 2,4,6-triisopropyl. Examples of suitable heterocyclic groups are 2-pyridinyl, 3-pyridinyl, 2-thiophenyl, 2-furanyl, 2-pyrrolyl, 2-quinolinyl. Suitable substituents for forming heterosubstituted derivatives of said groups R¹, R² and R³ are, for example, chloro, bromo, fluoro, iodo, nitro, amino, cyano, ether, hydroxyl and silyl, methoxy, ethoxy, phenoxy (i.e. —OC₆H₅), tolyloxy (i.e. —OC₆H₄(CH₃)), xylyloxy, mesityloxy, dimethylamino, diethylamino, methylethylamino, thiomethyl, thiophenyl and trimethylsilyl. Examples of suitable heterosubstituted derivatives of said groups (i) to (v) are 2-chloroethyl, 2-bromocyclohexyl, 2-nitrobenzyl, 4-ethoxybenzyl, 4-chloro-2-pyridinyl, 4-dimethylaminotoluyl and 4-methylamino-2-ethylnaphthyl.

When the group R⁴, R⁵ or R⁶ is heterocyclic, the atom or atoms present in the rings as the heteroatom can be for example, oxygen, nitrogen, sulphur, phosphorus or silicon.

In the case that R⁴ and R⁵ form the integral unit R⁶, said unit connects at each end via a carbon atom to the two terminal nitrogen atoms of the triazene unit in Formula C. R⁶ suitably comprises a chain of at least 3 carbon atoms, including the two terminal carbon atoms, optionally containing one or more hetero atoms selected from oxygen, nitrogen, sulphur, or silicon. R⁶ preferably comprises a chain of at least 6 carbon atoms, including the carbon atoms that connect to the terminal nitrogen atoms of the triazene unit. Although R⁴ and R⁵ can form integral unit R⁶ it is preferred that they are separate groups. Preferably R⁴ and R⁵ are separate, identical groups. R⁴ and R⁵ are preferably hydrocarbyl groups and more preferably alkyl groups. Examples of preferred alkyl groups are methyl, ethyl, isopropyl, isobutyl, tert-butyl, adamantyl, cyclopentyl, cyclohexyl and n-hexyl.

The invention is further illustrated with reference to the following Examples. In the Examples all manipulations of air/moisture-sensitive materials were performed on a conventional vacuum/inert atmosphere (nitrogen) line using standard Schlenk line techniques, or in an inert atmosphere glove box.

### EXAMPLE 1

### 1.1 Synthesis of the ligand 1,3-bis(2,6-diisopropylphenyl)triazene

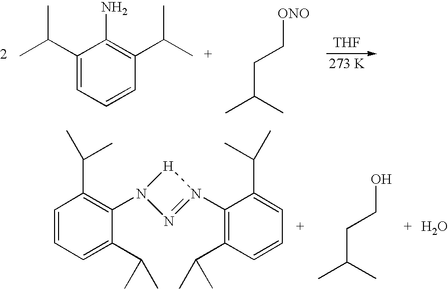

Isoamyl nitrite (13.42 ml; 100 mmol) was added dropwise over a period of 1.5 h (using a syringe pump) to a cooled (0° C.) solution of distilled 2,6-diisopropylaniline (9.41 ml; 50 mmol) in 100 ml of diethyl ether. The solution was stirred at room temperature for 18 h and then the solvents as well as the by-products (isoamyl alcohol and water) were removed under reduced pressure (0.05 Torr) at room temperature over a period of 3 hours since the final product is temperature sensitive. The resulting oil was dissolved in the minimum amount of nitromethane and cooled to −20° C. The crystalline product was filtered cold with a previously cooled filter and washed successively with small amounts of nitromethane until the filtrate was white. The product was dried in vacuo at 35°. (5.5 g; 15 mmol; 60%). ¹H NMR (CDCl₃, 250 MHz, 25° C.) δ 9.15 (broad s), 7.26-7.03 (m), 6.84 (d), 3.20 (broad m), 2.96 (septet), 1.19 (d), 1.11 (d). ¹³C NMR (CDCl₃, 250 MHz, 25° C.) δ 132.39, 127.07, 123.26, 122.74, 118.50, 28.02, 23.55, 22.42. IR (KBr pellets, cm⁻¹): 3405 (s), 3255 (s), 3050 (m), 3066 (m), 2958.4 (s), 2795 (m), 1646 (s), 1588 (s), 1558 (s), 1507 (s), 1456 (s), 1402 (m), 1385 (s), 1373 (s), 1362 (s), 1317 (s), 1290 (m), 1267 (m), 1207 (m), 1188 (m), 1142 (m), 1124 (w), 1103 (s), 1095 (s), 1045 (s), 1000 (s), 986 (s), 967 (s), 954 (s), 919 (s), 854 (m), 813 (m), 778 (m), 745 (m), 714 (m), 668 (m), 645 (m), 545 (w), 526 (w), 460(s), 422 (s). MS (m/z; FAB+ionisation): (M+1) 366. Anal. Calcd. (Found): C, 78.64; (79.07); H, 9.90; (9.40); N, 11.46; (11.53).

### 1.2 Synthesis of 1,3-bis(2,6-diisopropylplenyl)triazenido zirconium dichloride

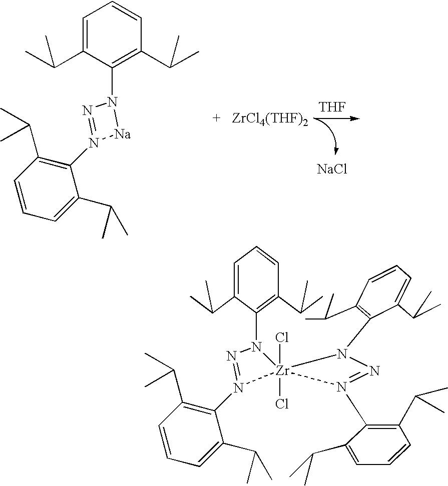

1,3-bis(2,6-diisopropylphenyl)triazene (2.90 g; 7.95 mmol) prepared as described in 1.1 above was dissolved in tetrahydrofuran (THF) (50 ml) and treated with NaH (0.19 g; 7.95 mmol) upon which there was gas evolution. The solution was stirred for 4 h and simultaneously filtered and cannulated slowly to a solution of ZrCl₄(THF)₂ (1.5 g; 3.98 mmol) in THF (75 ml). The reaction turned to a cloudy yellow suspension upon formation of the complex. The solvent was removed under reduced pressure, replaced with freshly distilled methylene chloride (20 ml) and filtered to remove LiCl. The solution was layered with heptane, which precipitated a yellow powder in a 61% yield. ¹H NMR (CDCl₃, 250 MHz, 25° C.) δ: 7.29-7.09 (m), 4.07 (broad m; coordinated THF), 3.45 (septet); 3.15 (septet); 1.73 (broad m; coordinated THF); 1.29-1.11 (m). IR (KBr pellets, cm⁻¹): 3057 (m), 2925 (s), 2851 (s) 1719 (s), 1617 (w), 1587 (m), 1523 (m), 1464 (s), 1378 (s), 1362 (m), 1327 (m), 1262 (m), 1241 (m), 1217 (w), 1179 (w), 1128 (w), 1090 (w), 1040 (m), 1005 (m), 960 (m), 926 (w), 848 (s), 802 (m), 774 (m), 760 (m), 722 (m), 666 (m).

### EXAMPLE 2

### 2.1 Synthesis of the ligand 1.3-bis(2,6-diisopropylphenyl)triazene

This was carried out as in Example 1.1 above.

### 2.2 Synthesis of a titanium complex of 1,3-bis(2,6-diisopropylphenyl)triazene

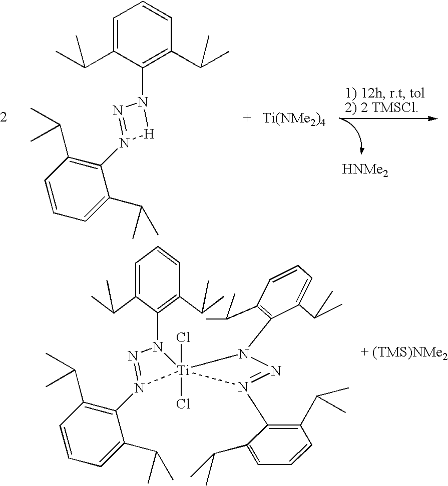

1,3-Bis(2,6-diisopropylphenyl)triazene (1.54 g; 4.22 mmol) was dissolved in toluene (50 ml). The solution was cannulated slowly to a solution of Ti(NMe₂)₄ (0.5 g; 2.11 mmol) in 75 ml of toluene cooled at −20° C. The solution was allowed to warm to room temperature upon which the colour of the solution turned to an orange/brown. The solvent was removed under reduced pressure and replaced with freshly distilled toluene (50 ml). The solution was then treated with trimethylsilyl chloride (0.54 ml; 4.22 mmol) upon which there was a slight colour change to a reddish brown colour. The solvent was evaporated and the solid was washed with hexane. (Yield 55%) ¹H NMR (CDCl₃, 250 MHz, 25° C.) δ: 7.09-6.80 (m), 4.67 (septet), 2.84 (septet); 2.25 (d); 1.38 (d); 1.20-0.88 (m). IR (KBr pellets, cm⁻¹): 3050 (m), 2958 (s), 2795 (s), 1733 (m), 1621 (m), 1583 (m), 1523 (m), 1467 (s), 1423 (s), 1380 (s), 1361 (m), 1334 (s), 1287 (s), 1257 (m), 1213 (w), 1177 (w), 1119 (m), 1056 (m), 1044 (m), 1021 (s), 1006 (s) 985 (m), 933 (w), 897 (s), 842 (w), 798 (m), 753 (s), 666 (m), 599 (w), 550 (m).

### EXAMPLE 3

### 3.1 Synthesis of the ligand 1.3-bis(adamantyl)triazene

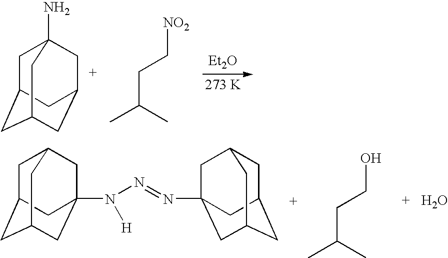

Isoamyl nitrite (13.42 ml; 100 mmol) was added dropwise over a period of 1.5 h (using a syringe pump) to a cooled (0° C.) solution of adamantamine (7.56 g; 50 mmol) in 100 ml of diethyl ether. The solution was stirred at room temperature for 18 h and then the solvents as well as the by-products (isoamnyl alcohol and water) were removed under reduced pressure (0.05 Torr) at room temperature over a period of 3 hours since the final product is temperature sensitive. The resulting oil was dissolved in the minimum amount of nitromethane and cooled to −20° C. The crystalline product was filtered cold with a previously cooled filter and washed successively with small amounts of hexane until the filtrate was white. The product was dried in vacuo at 35° C. (4.38 g; 14 mmol; 56%). ¹H NMR (CDCl₃, 250 MHz, 25° C.) δ: 9.28 (broad s), 2.02 (broad, s), 1.65 (broad, s), 1.55 (broad, s), 1.36 (broad, s), 0.93 (s), 0.91 (s). ¹³C NMR (CDCl₃, 250 MHz, 25° C.) δ: 48.10, 47.27; 46.14, 44.16, 38.23, 36.26, 34.17, 30.79, 28.70. IR (KBr pellets, cm⁻¹): 3338 (m), 3264 (m), 3170 (w), 2905 (s), 2847 (s), 2656 (w), 1592 (s), 1560 (s), 1545 (s), 1499 (w), 1451 (s),(m), 1356 (s), 1312 (s), 1284 (w), 1259 (w), 1186 (m), 1148 (s), 1095 (s), 1038 (w), 982 (m), 967 (s), 931 (s), 854 (m), 839 (s), 807 (s), 773 (m), 716 (w), 642 (w), 552 (w).

### 3.2 Synthesis of a titanium complex of 1,3-bis(adamantyl)triazene

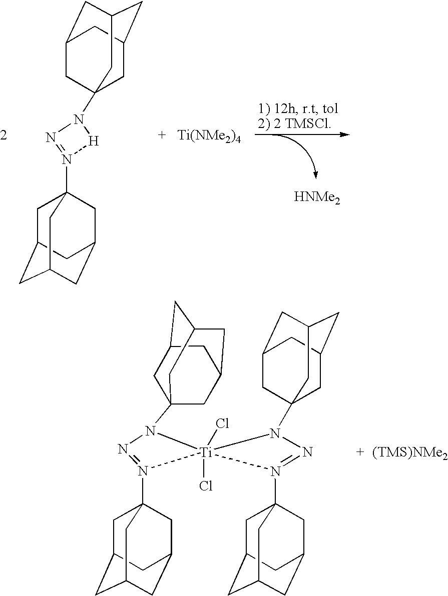

1,3-Bis(adamantyl)triazene (1.32 g; 4.22 mmol) was dissolved in toluene (50 ml). The solution was cannulated slowly to a solution of Ti(NMe₂)₄ (0.5 ml; 2.11 mmol) in toluene (75 ml) cooled at −20° C. On formation of the complex at room temperature, the solution turned to an orange/brown colour. The solvent was removed under reduced pressure and replaced with freshly distilled toluene (50 ml). The solution was then treated with TMSCl (0.54 ml; 4.22 mmol) upon which there was a slight colour change to a reddish brown colour. The solvent was evaporated and the solid was washed with hexane. (Yield 63%) ¹H NMR (CDCl₃, 250 MHz, 25° C.) δ: 1.90 (s, broad), 1.87 (s, broad), 1.63 (d); 1.53 (s); 1.45 (s).

### EXAMPLE 4

### 4.1 Synthesis of the ligand 1.3-bis(adamantyl)triazene

This was carried out as described in Example 3.1 above.

### 4.2 Synthesis of a zirconium complex of 1,3-bis(adamantyl)triazene

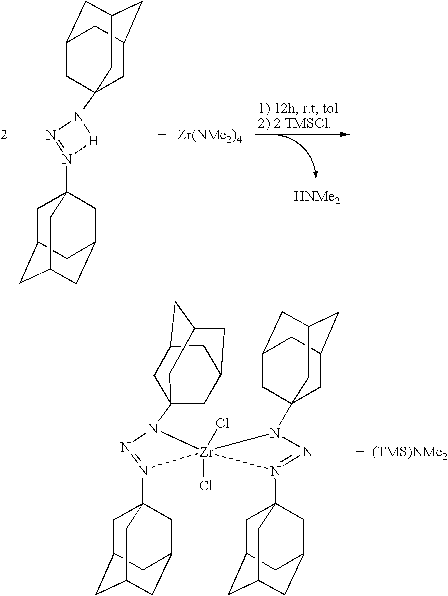

1,3-Bis(adamantyl)triazene (2.34 g; 7.48 mmol) was dissolved in of toluene (50 ml). The solution was cannulated slowly to a solution of Zr(NMe₂)₄ (1.0 g; 3.74 mmol) in 75 ml of toluene cooled at −20° C. The solution turned to an orange/brown colour after 18 h of stirring at room temperature. The solvent was removed in vacuo and replaced with freshly distilled toluene (50 ml). The solution was then treated with TMSCl (0.96 ml; 7.48 mmol) upon which there was a slight colour change to a reddish brown colour. The solvent was evaporated and the solid was washed with pentane. (Yield 76%) ¹H NMR (CDCl₃, 250 MHz, 25° C.) δ: 1.91 (s, broad), 1.85 (s, broad), 1.61 (d); 1.52 (s); 1.44 (s), 0.96 (m).

### EXAMPLES 1 to 4

### Catalyst Preparation and Polymerisation of Monomers

A solution of the transition metal complex (5 mmol) was prepared in 50 ml of solvent from which 1 ml of solution was used to do the polymerisation testing. The catalyst activator was injected into 150 ml of the anhydrous polymerisation. The Schlenk flask used for the polymerisation tests was then degassed three times and filled with ethene (25° C.) or propene (0° C.) at a pressure of 1. Once the temperature of polymerisation was established, the solution of transition metal complex was injected. For polymerisations in bulk propylene (example 3c), propylene was condensed into an autoclave before catalyst injection. The temperature of polymerisation in this case was 25° C. All polymerisations were run for 1 h.

Polymerisations were terminated after 1 h by venting gases and adding 20 ml of a 5% solution of HCl in methanol (MeOH) while stirring vigorously for 30 minutes. The polymer was filtered and the remaining aluminium salts were then washed out with water. In the case of polypropylene polymers, the organic phase was separated after filtration and the solvent was removed using a roto-evaporator to recover the soluble polypropylene fraction in the solvent.

### EXAMPLE 1

### Polymerisation Test Results

The complex employed was 1,3-bis(2,6-diisopropylphenyl)triazenido zirconium dichloride prepared as described in Example 1.2 above.

| | | | | Activity | | |
|---|---|---|---|---|---|---|
| | Activator | T | | (g/mmol · | Mw | |
| Test | (Al/M ratio) | (° C.) | Feed | atm · h) | (×10³) | PDI |
| 1a | MAO/TIBAL | 25 | ethene | 575 | 1985 | 211 |
| | (500/25) | | | | | |
| 1b | MAO/TIBAL | 0 | propene | 15 | 305 | 10 |
| | (500/25) | | | | | |

### EXAMPLE 3 and 4

### Polymerisation Test Results

The complexes employed to form the polymerisation catalysts were 1,3-bis(adamantyl)triazenido titanium & zirconium dichloride prepared as in Examples 3 and 4 and were as indicated below:

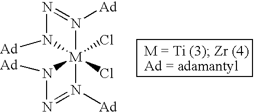

The following Table indicates the results of the polymerisation Tests:

| | Activator | T | | Activity | Mw | | |
|---|---|---|---|---|---|---|---|
| Catalyst | (Al/M ratio) | (° C.) | Feed | (g/mmol · atm · h) | (×10³) | PDI | % m₄ |
| 3a | MAO/TIBAL | 25 | ethene | 442 | 640 | 27.5 | N/A |
| | (500/25) | | | | | | |
| 3b | MAO/TIBAL | 0 | Propene | 138 | 128 | 2.9 | 12 |
| | (500/25) | | | | | | |
| 3c | MAO/TIBAL | 25 | Bulk | 5690 | 6610 | 3.8 | 3.1 |
| | (500/25) | | propene | | | | |
| 4a | MAO/TIBAL | 25 | ethene | 85 | 896 | broad | N/A |
| | (500/25) | | | | | | |
| 4b | MAO/TIBAL | 0 | propene | 15 | N/A | N/A | N/A |
| | (500/25) | | | | | | |

“PDI” is the polydispersity index Mw/Mn wherein Mw and Mn are measured by the gel permeation chromatographic methods well known in the art. A description of the application of these methods to the measurement of Mw/Mn for polyethylene and polypropylene in the present Examples is provided following Example 8 in this specification.
“% m₄” refers to the percentage of meso, meso, meso, meso pentad determined for polypropylene by C13 NMR [see Macromolecules volume 6, page 925 (1973) and volume 8, page 687 (1975)].

### EXAMPLE 5

### 5.1 Synthesis of 1,3-Bis(2,6-diisopropylphenyl)triazene

Isoamyl nitrite (11,7 g: 100 mmol) was added dropwise over 1 h to a cold (0° C.) solution of 2,6-diisopropylaniline (8.9 g, 50 mmol) in 100 ml diethyl ether. The reaction mixture was stirred at room temperature for 18 h and then the solvent and the excess of isoamyl nitrate were evaporated in vacuo at room temperature. The other volatile products (isoamyl alcohol and water) were evaporated at maximum 50° C. (0.05 torr). The resultant brown oil was dissolved in about 20 ml nitromethane and the solution was cooled to −15 to −20° C. A tan precipitate formed during intensive stirring of the nitromethane solution and scratching the walls of the flask. This was filtered at −20° C., washed with cold (−15-−20° C.) nitromethane (3×10 ml) and dried at room temperature under vacuum (0.05 torr). Yield 2.8 g (30%).

¹H-NMR (250 MHz, CDCl₃), δ, ppm, anti isomer: 1.20 (24H, d, J_{H—H}=7 Hz, CH₃), 3.20 (4H, m, CH), 7.25-7.17 (6H, m, C{Ar}—H), 9.14 (br. s, NH); syn isomer: 1.27 (24H, d, J_{H—H}=7 Hz, CH₃), 2.93 (4H, m, CH), 3.73 (br. s, NH), 7.16-7.02 (6H, m, C{Ar}—H);

### 5.2 Synthesis of 1,3-Bis(2,6-diisopropylphenyl)triazene zirconium dichloride.THF

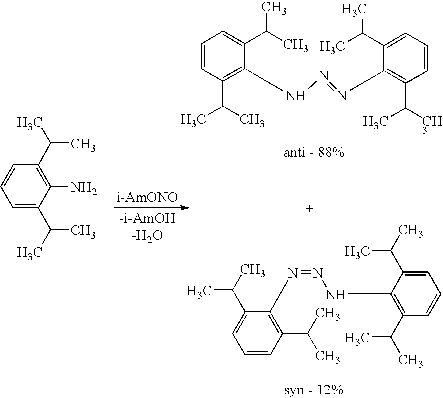

A solution of 1,3-bis(2,6-diisopropylphenyl)triazene (0.45 g: 1.24 mmol) in THF (40 ml), was added dropwise to n-butyllithium (0.5 ml of a 2.5 Molar solution: 1.24 mmol). After gas evolution had ceased the solution was filtered at −78° C. into a solution of ZrCl₄.2THF (0.25 g: 0.62 mmol) in 40 ml of THF. The reaction mixture was allowed to warm up to room temperature and stirred overnight. The mixture was then filtered and the filtrate evaporated to dryness. The residue was taken up with toluene (20 ml) and the solution mixed with 200 ml pentane (200 ml). The precipitate was filtered, washed with pentane and dried in vacuo. Yield—0.31 g (55%). +FAB-MS: 963 (M+), 526 [(M-L-THF)+], 456 [(ZrL)+].

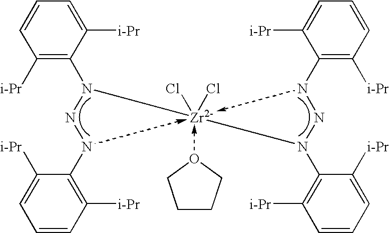

### EXAMPLE 6

### 6.1 Synthesis of 1,3-Bis(2,4,6-trimethylphenyl)triazene

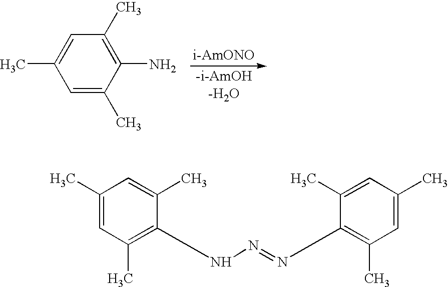

Isoamylnitrite (17.6 g, 150 mmol) was added dropwise at 0° C. over 1 hour to a solution of 2,4,6-trimethylaniline (10.1 g: 75 mmol) in diethyl ether (150 ml). The reaction mixture was stirred at room temperature for 18 hours and the volatiles evaporated in vacuo. The resulting oil was diluted with nitromethane (about 20 ml) and cooled to −30° C. Scratching the walls of the flask with a glass rod gave pale-yellow precipitate which was filtered, washed with cold nitromethane (5 ml) and dried in vacuo. Yield—3.9 g (36.9%). ¹H-NMR (250 MHz, CDCl₃), δ, ppm: 2.3-2.33 (overlapping s, 18H, Me), 6.94 (br. s, 4H, Ar—H), 9.17 (br. s, 1H, N—H).

### 6.2 Synthesis of 1,3-Bis(2,4,6-trimethylphenyl)triazenido zirconium dibenzyl and polymerisation of ethylene

Toluene (0.5 ml) was added at −78° C. to a mixture of tetrabenzylzirconium (10 mg: 22 μmol ) and 1,3-Bis(2,4,6-trimethylphenyl)triazene (12.4 mg: 44 μmol). The reaction mixture was allowed to warm up to room temperature during which time the colour of the solution changed to yellow. The mixture was stirred at room temperature for 45 min and then toluene (200 ml) was added. MAO (7.7 ml: 500 equivalents) was added and the reactor supplied with ethylene at 1 bar over 30 min. Methanol (100 ml) and HCl (10 ml: 2 Molar) were added to the reaction mixture after the end of the polymerisation. The precipitated polymer was filtered, washed with methanol and dried in vacuo. Yield 1.9 g. Activity 173 g/mmol.h.bar. Mn=4700; Mw=218000, Mw/Mn=46.3.

### EXAMPLE 7

### 7.1 Synthesis Bis-N,N-(2,6-diisopropylphenyl)triazenylphenyltriphenylphosphine nickel(II)

A 2.5 Molar solution of n-BuLi (1.5 ml: 3.86 mmol) in hexanes was added dropwise at 0° C. over 10 min to a solution of of 1,3-bis(2,6-diisopropyl-phenyl)triazene (1.41 g: 3.86 mmol) in toluene (30 ml). The reaction mixture was stirred at room temperature for 30 min and then bistriphenylphosphinephenylchloronickel(II) (2.7 g: 3.86 mmol) in THF (100 ml) was added. The resulting red-brown reaction mixture was stirred at room temperature for 3 h and the solvent evaporated. The residue was dissolved in toluene (about 10-15 ml). Heptane (60 ml) was added and the solution was filtered. Upon standing, an orange-red, crystalline precipitate was formed, which was filtered, washed with cold heptane and dried in vacuo. Yield—0.62 g (21%). Further concentration of filtrate gave additionally 1.3 g (44%) of the desired product.

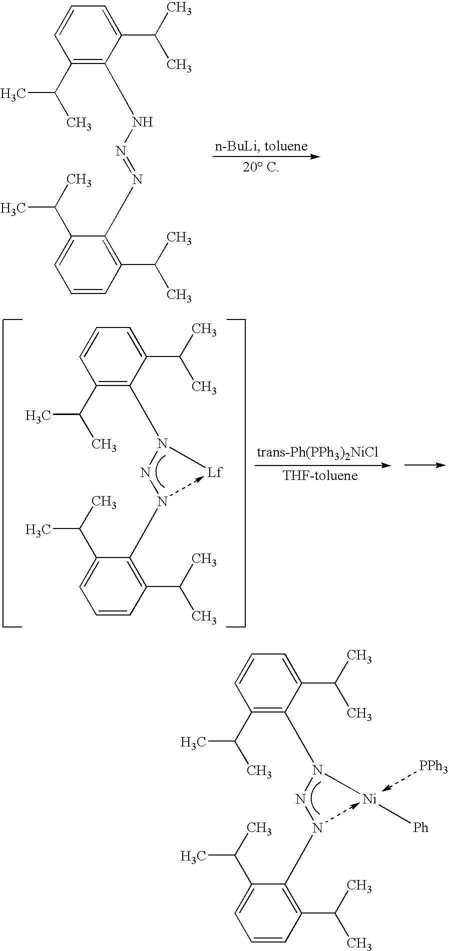

Analysis. Elemental analysis, calcd. (found): C—75.60(71.26), H—7.14(6.27), N—5.51(2.85). ¹H-NMR (250 MHz, C₆D₆), δ, ppm: 1.10 (6H, br. s, CH₃), 1.26 (3H, D, J_{H—H}=7.9 Hz), 1.44 (15H, m, CH3), 4.00 (1H, m, C—H), 4.48 (1H, m, C—H), 6.34-7.10 (18H, m, C{Ar}—H), 7.18-7.79 (8H, m, C{Ar}—H); ³¹P{¹H}-NMR (101 MHz, C₆D₆), δ, ppm: 25.37; MS (CI, NH₃), m/z (I, %): no M⁺, 734 (2)-M⁺-N₂, 720 (100)-M⁺-i-Pr; 557(100)-M⁺-i-Pr₂—C6H₃N₃H₂; 279 (85)-Ph₃PNH₃⁺; 263 (70)-H—PP₃⁺262 (30)-i-Pr2-C₆H₃N₃Ni.

### 7.2 Ethylene olizomerisation using Bis-N,N-(2,6-diisopropylphenyl)triazenylphenyl triphenylphosphine nickel(II)

A solution of the nickel complex (20 μmol) prepared above (para 7.1) and Ni(COD)₂ (100 μmol) as phosphine scavenger was stirred at 70° C. under ethylene (1 bar) for 1 hour. The GC-MS analysis of the reaction mixture after the completion of the reaction shows traces of hexenes and octenes.

### EXAMPLE 8

### 8.1 Synthesis of Bis(1,3-diphenyltriazene)zirconium dichloride.THF

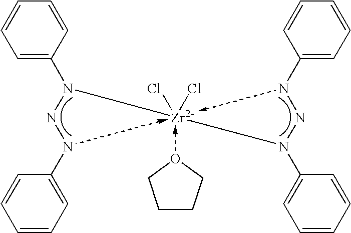

A solution of 1,3-diphenyltriazene (1.0 g: 5.1 mmol) in THF (40 ml) was added dropwise to NaH (0.61 g: 10.5 mmol). 1,3-diphenyltriazene is commercially available from Aldrich Chemicals. After the evolution of gas has ceased, the resulting orange solution was filtered at −78° C. into a solution of ZrCl₄.2THF (0.96 g: 2.6 mmol) in THF (40 ml). The reaction mixture was allowed to warm up to room temperature and stirred overnight. The mixture was then filtered and the filtrate evaporated to dryness. The residue was dissolved in toluene (20 ml) and the solution mixed with pentane (200 ml). The precipitate was filtered, washed with pentane and dried in vacuo. Yield 1.35 g (93.3%).

### 8.2 Ethylene Polymerisation using Bis(1,3-diphenyltriazene)zirconium dichloride.THF

Polymerisation of ethylene was carried out as described in Example 6.2 using, as complex, bis(1,3-diphenyltriazene)zirconium dichloride.THF (11.6 mg: 17.7 mmol) and MAO (7 ml: 560 equiv). The ethylene pressure was 1 bar, the polymerisation temperature was 65° C. and the polymerisation time was 30 minutes. Polyethylene yield was 0.25 g. Activity was 28 g/mmol.h.bar.

Notes: In the Examples

MAO=methylalumoxane

TIBAL=triisobutylaluminium

TMSCl=trimethylsilyl chloride

Ni(COD)₂=nickel bis(1,5-dicyclooctadiene)

Determination of Polydispersity (Mw/Mn) for Polyethylene and Polypropylene.

The polydispersity of polyethylene was determined using a commercially available Waters 150 CV. This method enables the molecular weight distribution (MWD) of polyolefins (e.g. polyethylene dissolved in 1,2,4-trichlorobenzene) to be determined. Gel Permeation Chromatography (GPC) separates polymer molecules in solution according to their molecular size (hydrodynamic volume). Once the GPC equipment has been calibrated with characterised standards (e.g. polystyrene), the experimental GPC chromatogram is converted to an intensity profile as a function of molecular weight. From this the molecular weight parameters of an unknown material are calculated. For polyethylene's trichlorobenzene is used at elevated temperatures of up to 170° C. in order to render the polymer soluble.

The system used to obtain GPC chromatograms at temperatures up to 150° C. is the Waters 150 CV. It is a non-modular system comprising:
(a) Solvent delivery pump capable of delivering 1.0 ml/min.
(b) A series of GPC columns appropriate to the “anticipated” molecular weight range of the polymer is used, e.g. 3 Shodex columns; 10⁷ Å, linear and 10⁴ Å. See the manufacturers' handbooks for individual column molecular weight ranges.
(c) An auto-injector with a 16-vial carousel.
(d) Refractive Index (RI) Detector.
(e) A single capillary viscosity (VI) detector.

The above units are enclosed within heated ovens maintaining constant temperature environments up to 150° C.
(f) Millipore 150 CV filter assembly (Type WATO 76615) used externally/manually for polyethylene samples of high gel content or containing fillers, colour materials etc.
(g) Usual laboratory apparatus and equipment including a four-figure analytical balance, volumetric flasks, vials and measuring cylinders.
   Reagents Used:

1,2,4-Trichlorobenzene, HPLC grade, e.g. FSA.

Santonox R®, Monsanto.

Monodisperse polystyrene reference standards with individual certification data issued by Polymer Labs.

Polyethylene Standard Reference Material (SRM) 1484a.

Polystyrene SRM 706.

Preparation of Polymer Standards

The 1,2,4-Trichlorobenzene (TCB) solvent containing 0.20±0.02 g/l Santonox R (hereafter referred to as TCB) is normally used after filtration (e.g. Millipore filtration kit with 0.5 μm filters). Single calibrant polymer solutions of 0.015% (highest molecular weight) to 0.250% (lowest molecular weight) w/v (normally in 10 ml solvent) were prepared. This is achieved by heating the polymer/solvent mixture at 155±15° C. for 1 to 2 hours until dissolved. Once dissolved, the polymer remains in solution even when cooled to ambient temperature.

As a guide a set of polystyrene (PS) calibrant samples of known molecular weight are listed below with suggested concentrations.

| Molecular Weight (PS) | Concentration (w/v %) |
|---|---|
| 15400000 | 0.020 (i.e. 2 mg in 10 ml TCB) |
| 5000000 | 0.020 |
| 1950000 | 0.025 |
| 1075000 | 0.050 |
| 629500 | 0.050 |
| 275000 | 0.100 |
| 156000 | 0.100 |
| 66000 | 0.125 |
| 28500 | 0.125 |
| 20650 | 0.125 |
| 10850 | 0.175 |
| 4750 | 0.175 |
| 3000 | 0.200 |
| 1700 | 0.200 |
| 1050 | 0.250 |
| 580 | 0.250 |

For molecular weights intermediate to those shown choose intermediate concentrations. To reduce the total running time of the calibrant samples, calibrant solutions containing more than one polymer have been used provided that the individual polymer peaks are well separated, e.g. one solution containing polystyrene standards 629.5K, 28.5K and 3000 molecular weights.

Preparation of Samples

Sample solutions containing approximately 7±3 mg polymer were prepared by weighing accurately (4 figure-balance) into a suitable receptacle (e.g. 100 ml glass container) and adding 25 ml TCB solvent. A 25 mm glass covered magnetic follower was placed in each container and covered with aluminium foil to minimise solvent evaporation.

The solution was heated in an oven at 155±5° C. for 5±3 hours until the polymer was dissolved. At approximately 2 hour intervals during this period the solution was placed on a magnetic hot plate stirrer and stirred for 1-2 minutes. This seemingly wide range of times and temperatures is found necessary to dissolve polymers ranging in Mw from 5,000 to 2,000,000 Daltons. Finally, about 3 ml of the polymer solution (at ca. 155° C.) is transferred to a carousel vial (at ca. 145° C.). The solution was injected into the GPC system without filtering unless the polyethylene contains residual catalyst material, gel or (coloured) filler. If filtering is required Waters WATO 76615 filters were used.

Apparatus Preparation

The 150 CV equipment consists of three integrated sections;

Pump—maximum compartment temperature of 60° C.,

Injector—maximum compartment temperature of 150° C.,

Columns—maximum compartment temperature of 150° C.

The compartment temperatures are programmed from room temperature to 60° C. (pump) and 140° C. (injector and columns) over a period of 16 hours (i.e. overnight) at a solvent flow rate of 0.1 ml/min.

The reference cell of the refractive index detector, the VI transducer and the injector should then be purged as described in the 150 CV manual.

Once the sample solutions in the carousel have been placed in the injector compartment, the column set is allowed to equilibrate for a minimum time of one hour (and preferably two hours) at a solvent flow rate of 1 ml/min.

The RI detector is set to a suitable sensitivity, e.g. 256 for polyethylene.

Calibration Procedure

A typical GPC injection sequence for the PS calibration standards is shown in Table 1 below. The frequency of calibration is at least every 3 months or unless the molecular weight distribution (MWD) values for 706 and/or 1484a fall outside their acceptable ranges. See computer/laboratory control charts for the current acceptable ranges

### Calibration Table

A Typical GPC Sample Injection Sequence for PS calibration standards (injection volume 300 μl)

| INJECTION | SAMPLE |
|---|---|
| 1 | 706 |
| 2 | 1484a |
| 3 | 15.4M |
| 4 | 5M |
| 5 | 1.95M, 156K, 20650, 1050 |
| 6 | 629.5K, 28500, 3000 |
| 7 | 275.2K, 10850, 1700 |
| 8 | 1.075M, 66K, 4750, 580 |
| 9 | 706 |
| 10 | 1484a |

Calculations

The calibration plot is obtained by integrating the polystyrene calibration peaks. A third order polynomial equation of calibrant molecular weight (or in terms of e.g. polyethylene molecular weight using values calculated from the appropriate Mark-Houwink K and α values) against elution volume is used.

Once the calibration plot has been established the sample molecular weight parameters are determined using the Waters Millennium software.

The following molecular weight parameters are calculated from the GPC software:

| | |
|---|---|
| Mn | number average molecular weight |
| Mw | weight average molecular weight |
| Mw/Mn | polydispersity |
| Mp | peak molecular weight |

For further information on the GPC method of determining these parameters reference should be made to analysis GPC literature and to, e.g. the Waters Millennium handbook.

Polypropylene

The following information is relevant to the measurement of these parameters for polypropylene samples.

Sample Dissolution

Approximately 20 mg of each sample is pressed into a thin film at 190° C. for 90 seconds under a pressure of 50 kN. Half of the resultant film is placed in 20 ml vial with 10 ml of stabilised 1,2,4 trichlorobenzene and dissolved with agitation at 160° C. for a period of two hours. Once dissolved the sample is transferred in to a 2 ml vial and placed in an autosampler kept at 150° C. During the process of transferring the solution care should be taken as undissolved high molecular weight material can block the pipette and such samples should not be injected into the GPC.

Chromatography

The instrument employed is a Polymer Laboratories High Temperature GPC220, fitted with a 40-position autosampler. Calibration is carried out using PL Easical polystyrene standards.

The sample is injected through a single 7.5 mm×150 mm (d×1) high throughput column kept at 160° C. with a TCB flow rate of 1 ml/min, resulting in a sample column time of six minutes. Detection is carried out using a refractive index detector.

For high throughput purposes the Mark Houwink constants chosen are k=15.6×10⁻⁵ and α=0.76. Molecular weight averages are calculated in the Polymer Labs software either manually or by auto calculation routines during HTA operation.

1. A polymerisation catalyst comprising
(1) a nitrogen-containing transition metal compound having the following Formula A, and 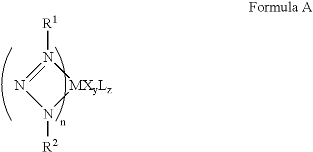
(2) an activating quantity of an activator compound selected from organoaluminium compounds and hydrocarbylboron compounds, wherein in, Formula A, either (a) R¹ and R² are monovalent groups connected to the terminal nitrogen atoms of the triazene unit via carbon in said monovalent groups or (b) R¹ and R² integrally form a divalent group R³ bridging the terminal nitrogen atoms of the triazene unit via carbon atoms;
the monovalent groups R¹ and R² and the divalent group R³ are independently selected from (i) aliphatic hydrocarbon, (ii) alicyclic hydrocarbon, (iii) aromatic hydrocarbon, (iv) alkyl substituted aromatic hydrocarbon (v) heterocyclic groups and (vi) heterosubstituted derivatives of said groups (i) to (v);
M is a metal from Group 3 to 11 of the Periodic Table or a lanthanide metal; X is an anionic group, L is a neutral donor group; n is 1 or 2, y and z are independently zero or integers such that the number of X and L groups satisfy the valency and oxidation state of the metal M.

2. A polymerisation catalyst as claimed in claim 1 wherein the monovalent groups R¹ and R² are selected from methyl, ethyl, ethylenyl, isopropyl, tert-butyl, adamantyl, cyclopentyl, cyclohexyl, phenyl, biphenyl, naphthyl, phenanthryl, anthryl, benzyl, tolyl, mesityl, 2,6-diisopropylphenyl and 2,4,6-triisopropyl, 2-pyridinyl, 3-pyridinyl, 2-thiophenyl, 2-furanyl, 2-pyrrolyl and 2-quinolinyl.

3. A polymerisation catalyst as claimed in claim 1 wherein the divalent group R³ is formed by formal removal of a hydrogen atom from a group selected from methyl, ethyl, ethylenyl, isopropyl, tert-butyl, adamantyl, cyclopentyl, cyclohexyl, phenyl, biphenyl, naphthyl, phenanthryl, anthryl, benzyl, tolyl, mesityl, 2,6-diisopropylphenyl and 2,4,6-triisopropyl, 2-pyridinyl, 3-pyridinyl, 2-thiophenyl, 2-furanyl, 2-pyrrolyl and 2-quinolinyl.

4. A polymerisation catalyst as claimed in claim 1 wherein R¹, R² and R³ are heterosubstituted derivatives of said groups (i), (ii), (iii), (iv) or (v) and wherein the hetero-substituent is selected from chloro, bromo, fluoro, iodo, nitro, amino, cyano, ether, hydroxyl and silyl, methoxy, ethoxy, phenoxy (i.e. —OC₆H₅), tolyloxy, xylyloxy, mesityloxy, dimethylamino, diethylamino, methylethylamino, thiomethyl, thiophenyl and trimethylsilyl.

5. A polymerisation catalyst as claimed in claim 1 wherein the group R¹, R² or R³ is heterocyclic and the atom or atoms present in the rings as the heteroatom are selected from oxygen, nitrogen, sulphur, phosphorus and silicon.

6. A polymerisation catalyst as claimed in any one of claims 1, 2, 4 or 5 wherein R¹ and R² are separate, identical groups.

7. A polymerisation catalyst as claimed in claim 6 wherein R¹ and R² are alkyl groups.

8. A polymerisation catalyst as claimed in claim 1 wherein M is selected from Sc, Ti, Zr, Hf, V, Nb, Ta, Cr, Mo, W, Mn, Fe, Ru, Co, Rh, Ir, Ni, Pd and Pt.

9. A polymerisation catalyst as claimed in claim 1 wherein the anionic group X is selected from halide, hydrocarbyl, carboxylate, oxide, amide, and alkoxide.

10. A polymerisation catalyst as claimed in claim 1 wherein X is a non-coordinating or weakly-coordinating anion.

11. A polymerisation catalyst as claimed in claim 10 wherein X is selected from tetrafluoroborate, fluorinated aryl borate and triflate.

12. A polymerisation catalyst as claimed in claim 1 wherein the activator compound (2) is an organoaluminium compound selected from trimethylaluminium, triethylaluminium, tributylaluminium, tri-n-octylaluminium, ethylaluminium dichloride, diethylaluminium chloride and an alumoxane, or a hydrocarbylboron compound selected from dimethylphenylammoniumtetra(phenyl)borate, trityltetra(phenyl)borate, triphenylboron, dimethylphenylammonium tetra(pentafluorophenyl)borate, sodium tetrakis[(bis-3,5-trifluoromethyl)phenyl]borate, H⁺(OEt₂)[(bis-3,5-trifluoromethyl)phenyl]borate, trityltetra(pentafluorophenyl)borate and tris(pentafluorophenyl)boron.

13. A polymerisation catalyst as claimed in claim 1 wherein the catalyst is supported on a support material.

14. A polymerisation catalyst as claimed in claim 13 wherein the support material is selected from silica, alumina, zirconia, magnesia or a polymer or prepolymer.

15. A polymerisation catalyst as claimed in claim 1 wherein the nitrogen-containing transition metal compound having the following Formula A is selected from
1,3-bis(2,6-diisopropylphenyl)triazenido zirconium dichlorides,
1,3-bis(2,6-diisopropylphenyl)triazenido titanium dichloride,
1,3-bis(adamantyl)triazenido titanium dichloride,
1,3-bis(adamantyl)triazenido zirconium dichlorides,
Bis(1,3-diphenyltriazene)zirconium dichloride.THF,
1,3-Bis(2,4,6-trimethylphenyl)triazenido zirconium dibenzyl,
Bis-N,N-(2,6-diisopropylphenyl)triazenylphenyltriphenylphosphine nickel(II) and
Bis(1,3-diphenyltriazene)zirconium dichloride.THF.

16. A catalyst as claimed in claim 1 and further comprising
a catalyst selected from Ziegler-Natta catalyst, metallocene-based catalyst and heat-activated supported chromium oxide catalyst.

17. A process for the polymerisation and copolymerisation of 1-olefins comprising contacting the monomeric 1-olefin under polymerisation conditions with the polymerisation catalyst claimed in claim 1.

18. A process as claimed in claim 17 wherein a monomer selected from ethylene, propylene, butene, hexene, and styrene is homopolymerised.

19. A process as claimed in claim 17 wherein ethylene and or propylene are copolymerised with a comonomer selected from 1-olefin, acrylic acid ester, vinyl ester and vinyl aromatic compound.

20. A transition metal compound having the Formula C 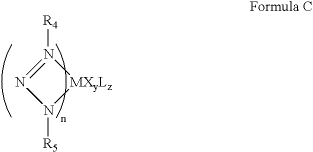
wherein either (a) R⁴ and R⁵ are monovalent groups connected to the terminal nitrogen atoms of the triazene unit of Formula C via carbon in said monovalent groups or (b) R⁴ and R⁵ integrally form a divalent group R⁶ bridging the terminal nitrogen atoms of the triazene unit of Formula A via carbon atoms;
the monovalent groups R⁴ and R⁵ and the divalent group R⁶ are independently selected from (i) aliphatic hydrocarbon, (ii) alicyclic hydrocarbon, (iii) alkyl substituted aromatic hydrocarbon (iv) heterocyclic groups and (v) heterosubstituted derivatives of said groups (i) to (iv);
M is a metal from Group 3 to 11 of the Periodic Table or a lanthanide metal; X is an anionic group; L is a neutral donor group; n is 1 or 2; y and z are independently integers such that the number of X and L groups satisfy the valency and oxidation state of the metal M.

21. Propylene homopolymer or propylene copolymer having a weight average molecular weight in the range 0.7×10⁶ to 2.0×10⁷.

22. Propylene homopolymer or propylene copolymer having a weight average molecular weight in the range 1×10⁶ to 1.6×10⁷.

23. Propylene homopolymer or propylene copolymer having a weight average molecular weight in the range 2×10⁶ to 1.20×10⁷.

24. A propylene copolymer as claimed in any one of claims 21 to 23 comprising 0.01 to 20 weight % based on the total weight of copolymer of one or more olefins selected from ethylene and C₄ to C₁₂ 1-olefins.

25. (canceled)
